(19) United States
(12) Patent Application Publication
(10) Pub. No.: US 2004/0215653 A1
(43) Pub. Date: Oct. 28, 2004

(54) Work management program, work management system and computer-readable recording medium with program recorded thereon

(75) Inventor: Noriyuki Yanagimachi, Matsudo-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Minolta Medical & Graphic, Inc., Tokyo (JP)

(21) Appl. No.: 10/817,677

(22) Filed: Apr. 2, 2004

(30) Foreign Application Priority Data
Apr. 10, 2003 (JP) JP2003-107066

(51) Int. Cl. G06F 7/00

(52) U.S. Cl. 707/102

(57) ABSTRACT

A work management program for allowing a computer to perform the function of managing a work set on a job as a work item. The work management program has a storing function to store work information including a work name and work status; a classification function to classify the work status into any one of “scheduled” work status, “entry” work status and “completed” work status; a selecting function to select work information, satisfying a predetermined condition, of the work classified to either the “scheduled” work status or the “completed” work status, and work information of the work classified to the “entry” work status; an acquiring function to acquire the work information selected; and a display function to display the work information acquired.

### BACKGROUND OF THE INVENTION

The present invention relates to a work management program, a work management system and a computer-readable recording medium with work management program recorded thereon, particularly to a work management program and work management system capable of managing the work progress, and a computer-readable recording medium with work management program recorded thereon.

A program for work management by work progress displayed on a computer is commonly known in the conventional art. For example, information for work management is displayed for individual work to be managed, and work management is carried out.

In such a program, when work is divided into a great number of categories as in the prepress work, and there are a great number of types of work that must be managed, it is difficult to find out the information of the relevant work due to enormous volumes of work information to be displayed, with the result that work management will be retarded.

To solve this problem, the present inventors paid attention to that fact that work status can be broadly divided into three types; “scheduled”, “entry” and “completed”, and the status of the work being in entry is likely to change, and is particularly important for work management, and have worked out a method for displaying only the work of entry status. The work “being in entry” or the work of “entry status” refers to the work that can be started.

It is sometimes convenient to perform the work in the entry status by making reference to the information of the work in the scheduled or completed status. For example, work speed of the work currently being in entry can be adjusted if the scheduled entry date of the work in the scheduled status, i.e. the date when the work reaches the entry status, is used as work information. Further, in the work finished by the repetition of the work statuses of “scheduled”, “entry” and “completed” in that order for a work item, the work where a series of work statuses is repeated is managed as a version for each cycle, and the current work is performed based on the result of an immediately previous version. In such work, if the content of the work in the completed status can be referred to as work information, the setup work efficiency can be improved by making reference to such work information, and the work currently being in entry can be changed to have a desired content. Further, since the work outdated the scheduled entry date has a higher priority in management, it is preferable to be managed in the same manner as the work being in entry.

During the course of further investigation, the present inventors has reached the present invention by paying attention to the fact that the work in the scheduled status must be performed earlier, as scheduled entry date is closer to the current date; and the work in the completed status, if a series of work is repeated, is more relevant to the work presently being in entry, as the accomplished completion date, i.e. the date when the work reaches the completed status, is closed to the current date.

The object of the prevent invention is to provide a work management program and work management system allowing effective referencing of highly available work information, and a computer-readable recording medium with program recorded thereon.

Another object of the present invention will be apparent from the following description of this Specification:

### SUMMARY OF THE INVENTION

The aforementioned objects can be achieved by the invention having the following features:

(1) A work management program for allowing a computer to perform the function of managing the work set on the job as a work item, wherein the aforementioned computer performs:

a work information storing function of storing the work information including the name and status of the aforementioned work;

a classification function of classifying the aforementioned work status into any one of the “scheduled”, “entry” and “completed” statuses;

a selecting function for selecting work information, which satisfies the predetermined condition, of the work in either “scheduled” or “completed” status as classified according to the aforementioned classification function, and for selecting work information on the work in the “entry” status as classified according to the aforementioned classification function;

an acquiring function for acquiring the aforementioned selected work information; and

a display function for displaying the aforementioned acquired work information.

### BRIEF DESCRIPTION OF THE DRAWINGS

FIG. 1 is a function block diagram representing a work management system of the present invention;

FIGS. 2(a) through (c) show examples of the configuration of each table;

FIG. 3 is a diagram representing an example of changing a work status based on the command in a work status change section;

FIG. 4 is a diagram showing an example of the work status information table; and

FIG. 5 is a diagram representing an example of a process flow in the selecting section.

### DETAILED DESCRIPTION OF THE PREFERRED EMBODIMENT

The following further describes the features of the present invention for solving the aforementioned problems:

(2) A work management program described in the aforementioned item (1) characterized in that the aforementioned work information contains the work name, work status, a scheduled entry date and an accomplished completion date.

(3) The work management program, described in the aforementioned item (2), that allows a computer to perform a range-of-days storing function for storing the scheduled range-of-days and a completion range-of-days, and a present date storing function for storing the present date;

wherein the condition predetermined in the aforementioned selecting function satisfies the formula (1) for the information of the work in the “scheduled” state, and satisfies the formula (2) for the information of the work in the “completed” state.

Scheduled entry date≦present date+scheduled range of days (Formula 1)

Accomplished completion date≧present date−completion range of days (Formula 2)

(4) The work management program, described in the aforementioned item (2), that allows a computer to perform a range-of-days storing function for storing the scheduled range-of-days and a present date storing function for storing the present date;

wherein the condition predetermined in the aforementioned selecting function satisfies the formula (3) for the information of the work in the “scheduled” state, and satisfies the formula (4) for the information of the work in the “completed” state.

Scheduled entry date<present date+scheduled range of days (Formula 3)

Accomplished completion date>present date−completion range of days (Formula 4)

(5) The work management program, described in the aforementioned item (2), that allows a computer to perform a range-of-days storing function for storing the scheduled range of days and completion range of days, and a present date and hour storing function for storing the present date and hour;

wherein the condition predetermined in the aforementioned selecting function satisfies the formula (5) for the information of the work in the “scheduled” state, and satisfies the formula (6) for the information of the work in the “completed” state.

Scheduled entry date and hour≦present date and hour+scheduled range of days (Formula 5)

Accomplished completion date and hour≧present date and hour−completion range of days (Formula 6)

(6) The work management program, described in the aforementioned item (2), that allows a computer to perform a range-of-days storing function for storing the scheduled range of days and a present date and hour storing function for storing the present date and hour;

wherein the condition predetermined in the aforementioned selecting function satisfies the formula (7) for the information of the work in the “scheduled” state, and satisfies the formula (8) for the information of the work in the “completed” state.

Scheduled entry date and hour<present date and hour+scheduled range of days (Formula 7)

Accomplished completion date and hour>present date and hour−completion range of days (Formula 8)

(7) The work management program according to any one of the aforementioned items (1) through (6) wherein the aforementioned work status contains “Reserved”, “Not started yet”, “Started”, “Interrupted”, “Terminated” and “Settled” statuses, the aforementioned work management program further characterized in that:

the status of the work that has not yet been started and cannot be started is defined as “Reserved”;

the status of the work that has not yet been started and can be started is defined as “Not started yet”;

the status of the work being executed is defined as “Started”;

the state of the work having been interrupted is defined as “Interrupted”;

the state of the work that has been terminated and can be restarted is defined as “Terminated”; and

the state of the work that has been terminated and cannot be restarted is defined as “Settled”.

(8) The work management program according to any one of the aforementioned items (1) through (7) wherein the aforementioned work classification function operates in such a way that:

the information on the work whose status is “Reserved” is classified as “Scheduled” status; the information on the work whose status is “Not started yet”, “Started”, “Interrupted” or “Terminated” is classified as “Entry” state; and

the information on the work whose status is “Settled” is classified as “Completed” status.

(9) The work management program according to any one of the aforementioned items (1) through (8) wherein a computer is allowed to perform the renewing function for receiving the instruction to renew the work information displayed by the aforementioned display function in such a way that, when the instruction to renew the work information by means of the renewing function has been received, selection is made by the aforementioned selecting function, acquisition is made by the acquiring section based on this selection, and display is given by the display function based on this acquisition.

(10) A work management system for managing the work set on the job as a work item, wherein the aforementioned work management section comprises:

a work information storing section of storing the work information including the name and status of the aforementioned work;

a classification section of classifying the aforementioned work status into any one of the “scheduled”, “entry” and “completed” statuses;

a selecting section for selecting work information, which satisfies a predetermined condition, of the work in either “scheduled” or “completed” status as classified according to the aforementioned classification function, and for selecting work information on the work in the “entry” status as classified according to the aforementioned classification function;

an acquiring section for acquiring the aforementioned selected work information; and

a display section for displaying the aforementioned acquired work information.

(11) The work management system described in item (10) characterized in that the aforementioned work information contains the work name, the work status, a scheduled entry date and an accomplished completion date.

(12) The work management system according to the aforementioned item (11) further comprising:

a range-of-days storing section for storing the scheduled range of days and completion range of days, and a present date storing section for storing the present date;

wherein the condition predetermined in the aforementioned selecting section satisfies the formula (1) for the information of the work in the scheduled state, and satisfies the formula (2) for the information of the work in the completed state.

Scheduled entry date≦present date+scheduled range of days (Formula 1)

Accomplished completion date≧present date−completion range of days (Formula 2)

(13) The work management system according to the aforementioned item (11) comprising:

a range-of-days storing section for storing the scheduled range of days and completion range of days, and a present date storing section for storing the present date;

wherein the condition predetermined in the aforementioned selecting section satisfies the formula (3) for the information of the work in the scheduled state, and satisfies the formula (4) for the information of the work in the completed state.

Scheduled entry date<present date+scheduled range of days (Formula 3)

Accomplished completion date>present date−completion range of days (Formula 4)

(14) The work management system according to the aforementioned item (11) comprising:

a range-of-days storing section for storing the scheduled range of days and completion range of days, and a present date and hour storing section for storing the present date and hour;

wherein the condition predetermined in the aforementioned selecting section satisfies the formula (5) for the information of the work in the scheduled state, and satisfies the formula (6) for the information of the work in the completed state.

Scheduled entry date and hour≦present date and hour+scheduled range of days (Formula 5)

Accomplished completion date and hour≧present date and hour−completion range of days (Formula 6)

(15) The work management system according to the aforementioned item (11) comprising:

a range-of-days storing section for storing the scheduled range of days and completion range of days, and a present date storing section for storing the present date and hour;

wherein the condition predetermined in the aforementioned selecting section satisfies the formula (7) for the information of the work in the scheduled state, and satisfies the formula (8) for the information of the work in the completed state.

Scheduled entry date and hour<present date and hour+scheduled range of days (Formula 7)

Accomplished completion date and hour>present date and hour−completion range of days (Formula 8)

(16) The work management system according to any one of the aforementioned items (10) through (15) wherein the aforementioned work status contains “Reserved”, “Not started yet”, “Started”, “Interrupted”, “Terminated” and “Settled” statuses, the aforementioned work management program further characterized in that:

the status of the work that has not yet been started and cannot be started is defined as “Reserved”;

the status of the work that has not yet been started and can be started is defined as “Not started yet”;

the status of the work being executed is defined as “Started”;

the state of the work having been interrupted is defined as “Interrupted”;

the state of the work that has been terminated and can be restarted is defined as “Terminated”; and

the state of the work that has been terminated and cannot be restarted is defined as “Settled”.

(17) The work management system according to any one of the aforementioned items (10) through (16) wherein the aforementioned work classification section operates in such a way that:

the information on the work whose status is “Reserved” is classified as “Scheduled” status;

the information on the work whose status is “Not started yet”, “Started”, “Interrupted” or “Terminated” is classified as “Entry” state; and

the information on the work whose status is “Settled” is classified as “Completed” status.

(18) The work management system according to any one of the aforementioned items (10) through (17) comprising a renewing section for receiving the instruction to renew the work information displayed by the aforementioned display section, the aforementioned work management system further characterized in that, when the instruction to renew the work information by means of the renewing section has been received, selection is made by the aforementioned selecting section, acquisition is made by the acquiring section based on this selection, and display is given by the display section based on this acquisition.

(19) A computer-readable recording medium recording the program described in any one of the aforementioned items (1) through (9).

### DESCRIPTION OF THE PREFERRED EMBODIMENT

The following describes the preferred embodiments of the present invention with reference to drawings:

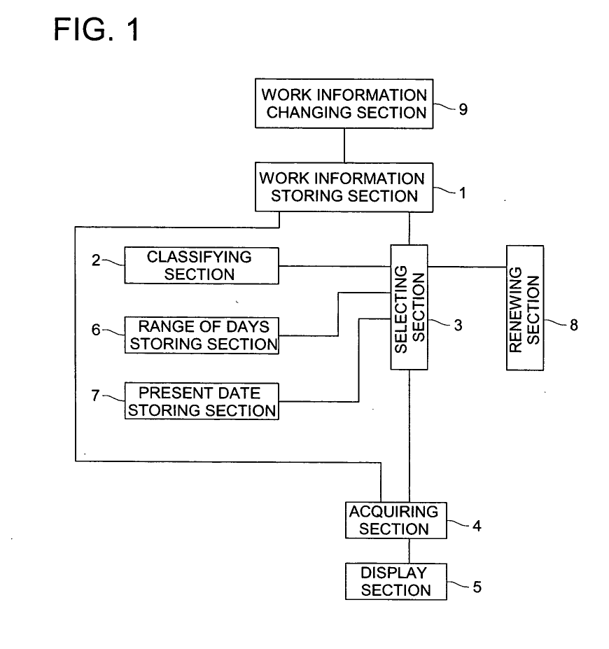

Referring to FIGS. 1 through 5, the following describes the work management system of the present invention:

As shown in FIG. 1, the work management system of the present invention comprises a work information storing section 1, a classifying section 2, a selecting section 3, an acquiring section 4 and a display section 5. Preferably, it is further equipped with a range-of-days storing section 6, a present date storing section 7, a renewing section 8 and work information changing section 9.

In FIG. 1, in order to manage the work set on the job as a work item, the work information storing section 1 stores the work information containing the aforementioned work name and work status. A plurality of work items can be set on the job as a work item. The greater the number of work items set on the job, the greater the effect provided by the work management system of the present invention. This is more preferable.

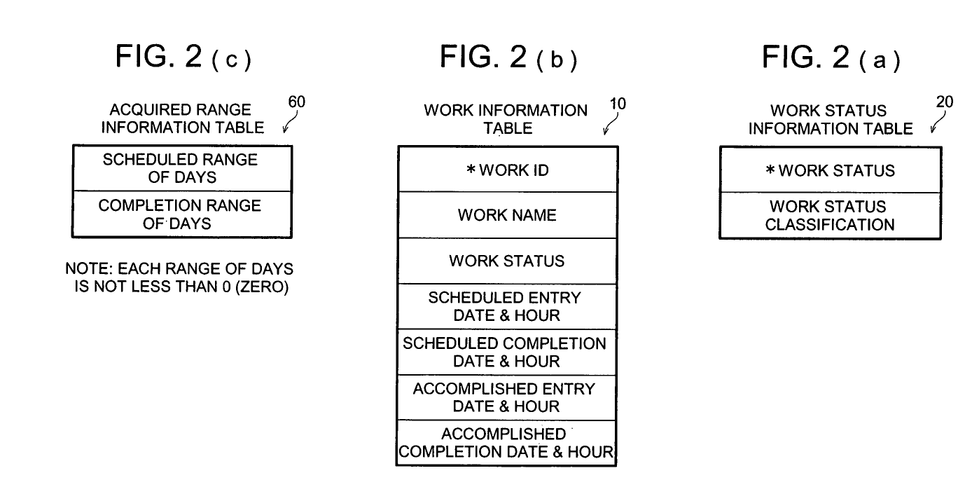

It is preferred that the work information stored in the work information storing section 1 contain the work name, work status, scheduled entry date and accomplished completion date. The work information storing section 1 can be provided with work information table 10, for example, as shown in FIG. 2(b). This will ensure better selection by the selecting section 3, as will be described later.

The scheduled entry date is the information indicating the scheduled date when it becomes possible to start the work; Oct. 11, 2000, for example. The accomplished completion date is the information showing the date when work has terminated and cannot be restarted; Nov. 11, 2000, for example.

It is preferred that the work status includes “Reserved”, “Not started yet”, “Started”, “Interrupted”, “Terminated” and “Settled” statuses. In this case, the status of the work that has not yet been started and cannot be started is defined as “Reserved”; the status of the work that has not yet been started and can be started is defined as “Not started yet”; the status of the work being executed is defined as “Started”; the state of the work having been interrupted is defined as “Interrupted”; the state of the work that has been terminated and can be restarted is defined as “Terminated”; and the state of the work that has been terminated and cannot be restarted is defined as “Settled. The work information storing section 1 stores these work statuses.

“Work . . . can be started” refers to the status where the work is enabled and can be performed by an operator using the data of the job on which the work is set as a work item, and “work . . . cannot be started” refers to the status where the work is disabled and cannot be performed.

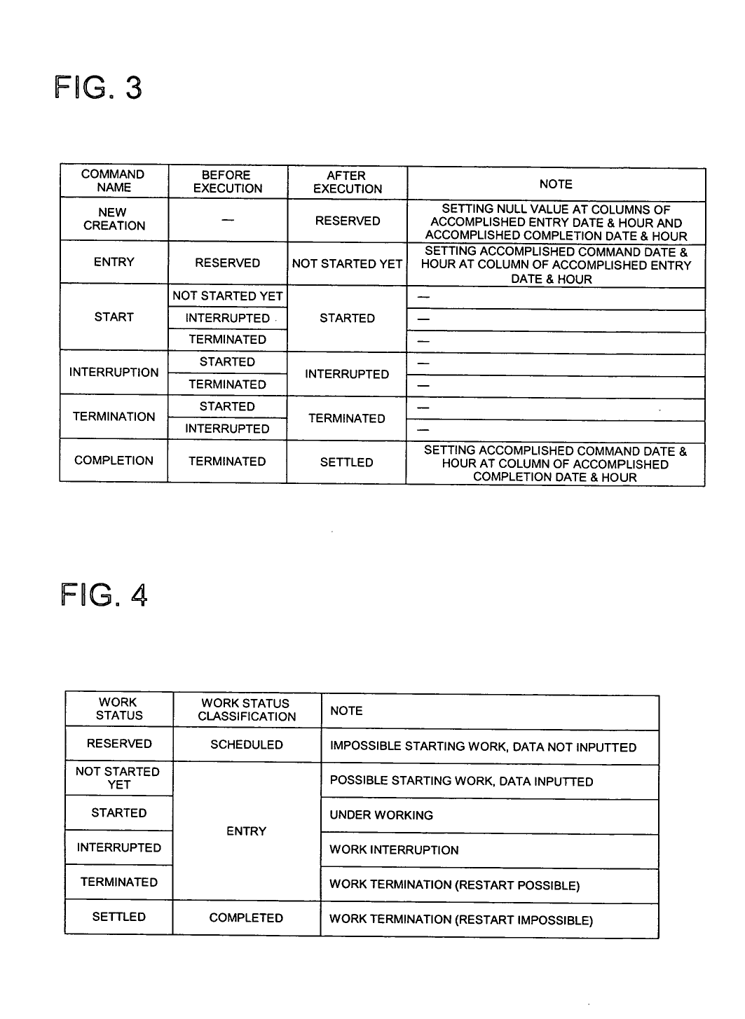

The work information of the work information storing section 1 is changed by the work information changing section 9 that is preferred to be provided. The work information changing section 9 is used to change the work information in response to and based on the input made by the user. For example, as shown in FIG. 3, when an entry command has been inputted for the work of the Reserved status, the work status is changed to the “Not started yet” status. Similarly, when “Start”, “Interruption”, “Termination” or “Complettion” command has been inputted for the status of the work prior to execution, the work status is changed to the specified one.

The classifying section 2 classifies the aforementioned work status into any one of the “Scheduled”, “Entry” and “Completed”. A work status information table 20 shown in FIG. 2(a) is provided for classification by the classifying section 2. It is preferred that information on the work of the “Reserved” status be classified as the information on “Scheduled” work status by this table, and the information on the work of the “Settled” status be classified as the information on “Completed” status. The work status information table 20 of the classifying section 2 can be formed into a table for classifying work statuses, as shown in FIG. 4, for example.

The selecting section 3 selects the information of the work in either “Scheduled” or “Completed” status as classified by the aforementioned classifying section wherein this information satisfies the predetermined condition, as well as the information on the work in the “entry” status.

It is also preferred to contain a range-of-days storing section 6 for storing the scheduled range of days and completion range of days, and a present date storing section 7 for storing the present date. The range-of-days storing section 6 can be formed as an acquired range information table 60 as shown in FIG. 2(c).

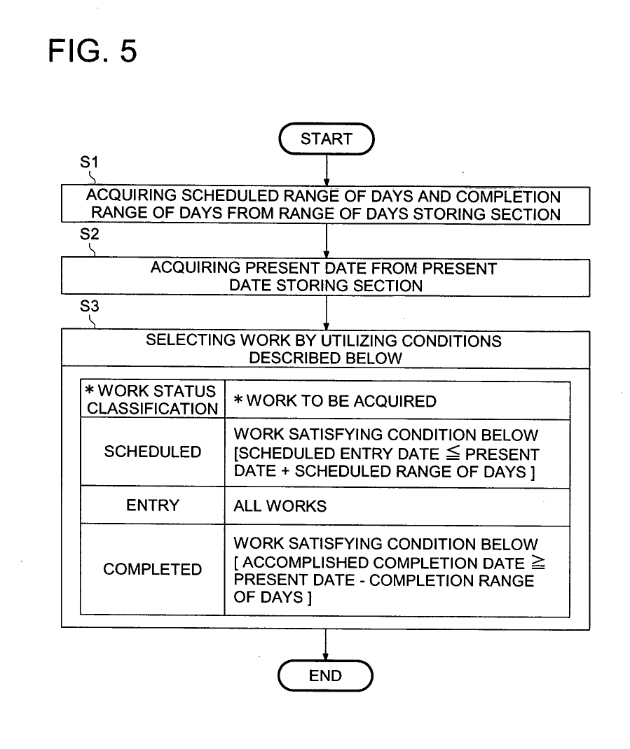

When the range-of-days storing section 6 and present date storing section 7 are provided, the selecting section 3 acquires the information on scheduled range of days and completion range of days from the range-of-days storing section 6 as shown in FIG. 5(S1), and the information on the present date from the present date storing section 7(S2). Then it selects the work under the predetermined condition (S3).

The predetermined condition in step S3 contains four embodiments: In the first embodiment, the formula (1) is satisfied for the information of the work in the scheduled state, and the formula (2) is satisfied for the information of the work in the completed state. The aforementioned “scheduled range of days” is the numerical representation, in terms of the number of days, of the range of the scheduled days when the work is brought to the entry status. The completion range of days is the numerical representation of the range of the work completion dates in terms of the number of days.

Scheduled entry date≦present date+scheduled range of days (Formula 1)

Accomplished completion date≧present date−completion range of days (Formula 2)

The Formula (1) is satisfied by the work whose scheduled entry date is on and before April 6, three days after April 3, for example, if the present date is April 3 and the scheduled range of days is three days.

The Formula (2) is satisfied by the work whose accomplished completion date denoting the date of work completion is on and after April 1, two days before April 3, for example, if the present date is April 3 and the completion range of days is two days.

In the second embodiment, formula (3) instead of formula (1) is satisfied, and formula (4) instead of formula (2) is satisfied.

Scheduled entry date<present date+scheduled range of days (Formula 3)

Accomplished completion date>present date−completion range of days (Formula 4)

The Formula (3) is satisfied by the work whose scheduled entry date is before April 6 (not including April 6), three days after April 3, for example, if the present date is April 3 and the scheduled range of days is three days.

The Formula (4) is satisfied by the work whose accomplished completion date denoting the date of work completion is after April 1 (not including April 1), two days before April 3, for example, if the present date is April 3 and the completion range of days is two days.

In the third embodiment, formula (5) instead of formula (1) is satisfied, and formula (6) instead of formula (2) is satisfied.

Scheduled entry date and hour≦present date and hour+scheduled range of days (Formula 5)

Accomplished completion date and hour≧present date and hour−completion range of days (Formula 6)

The Formula (5) is satisfied by the work whose scheduled entry date is on and before 15:00, April 6, three days after 15:00, April 3, for example, if the present date and hour is 15:00, April 3 and the scheduled range of days is three days.

The Formula (6) is satisfied by the work whose accomplished completion date and hour denoting the date and hour of work completion is on and after 15:00, April 1, two days before April 3, for example, if the present date and hour is 15:00, April 3 and the completion range of days is two days.

In the fourth embodiment, formula (7) instead of formula (1) is satisfied, and formula (8) instead of formula (2) is satisfied.

Scheduled entry date and hour<present date and hour+scheduled range of days (Formula 7)

Accomplished completion date and hour>present date and hour−completion range of days (Formula 8)

The Formula (7) is satisfied by the work whose scheduled entry date is before 15:00, April 6 (not including 15:00, April 6), three days after 15:00, April 3, for example, if the present date and hour is 15:00, April 3 and the scheduled range of days is three days.

The Formula (8) is satisfied by the work whose accomplished completion date and hour denoting the date and hour of work completion is before 15:00, April 1 (not including 15:00, April 1), two days before 15:00, April 3, for example, if the present date and hour is 15:00, April 3 and the completion range of days is two days.

In the case of formulae 5, 6, 7 and 8, it is preferred that the scheduled entry date and hour, instead of scheduled entry date included in the work information stored in the work information storing section 1, and accomplished completion date and hour, instead of accomplished completion date be included. The present date storing section 7 stores the present date and hour, and the present date and hour, instead of the present date, is acquired in step S2.

The acquiring section 4 acquires the work information selected in the aforementioned selecting section 3.

The display section 5 displays the work information acquired by the acquiring section 4. Display by the display section 5 may be given on a monitor screen or the like by electric means or on such a recording medium as paper by means of printing.

The renewing section 8 receives the input command for renewing the display content in the display section 5, and, based on this input command, gives an instruction to the selecting section 3 to make a new selection.

As described above, the work management system of the present invention allows the acquiring section 4 to acquire only the work information selected by the selecting section 3, and this information is displayed on the display section 5, whereby highly available work information is displayed for effective referencing. Further, the work information for the scheduled work and that for completed work can be displayed separately in terms of the range of days or hours. This system arrangement provides a system that meets the individual requirement, for example, of displaying the scheduled work in greater amounts or the completed work in greater amounts.

The aforementioned work management system can be implemented as a hardware resource (personal computer, etc.) loaded with a software application for realizing the work management program of the present invention.

A commonly known recording medium such as an FD (flexible disk), a CD-ROM or an MO (magneto-optical disk) can be utilized as a computer-readable recording medium with a program of the present invention recorded thereon.

What is claimed is:

1. A work management program for allowing a computer to perform the function of managing a work set on a job as a work item, the work management program comprising:
a work information storing function to store work information including a work name and work status;
a classification function to classify the work status into any one of “scheduled” work status, “entry” work status and “completed” work status;
a selecting function to select work information, satisfying a predetermined condition, of the work classified to either the “scheduled” work status or the “completed” work status, and work information of the work classified to the “entry” work status;
an acquiring function to acquire the work information selected; and
a display function to display the work information acquired.

2. The work management program of claim 1, wherein the work information includes the work name, the work status, a scheduled entry date and an accomplished completion date.

3. The work management program of claim 2, further comprising:
a range-of-days storing function to store a range of days including a scheduled range of days, and a completion range of days; and
a present date storing function to store a present date,
wherein the predetermined condition is to satisfy a formula (1) for the information of the work in the “scheduled” work status, and to satisfy a formula (2) for the information of the work in the “completed” work status,
Scheduled entry date≦Present date+Scheduled range of days Formula (1)
Accomplished completion date≧Present date−Completion range of days. Formula (2)

4. The work management program of claim 2, further comprising:
a range-of-days storing function to store a range of days, including a scheduled range of days and a completion range of days; and
a present date storing function to store a present date, wherein the predetermined condition is to satisfy a formula (3) for the information of the work in the “scheduled” work status, and to satisfy a formula (4) for the information of the work in the “completed” work status,
Scheduled entry date<Present date+Scheduled range of days Formula (3)
Accomplished completion date>Present date−Completion range of days. Formula (4)

5. The work management program of claim 2, further comprising:
a range-of-days storing function to store a range-of-days, including a scheduled range of days and a completion range of days; and
a present date and hour storing function to store a present date and hour, wherein the predetermined condition is to satisfy a formula (5) for the information of the work in the “scheduled” work status, and to satisfy a formula (6) for the information of the work in the “completed” work status,
Scheduled entry date and hour≦Present date and hour+Scheduled range of days Formula (5)
Accomplished completion date and hour≧Present date and hour−Completion range of days. Formula (6)

6. The work management program of claim 2, further comprising:
a range-of-days storing function to store a range-of-days, including a scheduled range of days and a completion range of days; and
a present date and hour storing function to store a present date and hour, wherein the predetermined condition is to satisfy a formula (7) for the information of the work in the “scheduled” work status, and to satisfy a formula (8) for the information of the work in the “completed” work status,
Scheduled entry date and hour<Present date and hour+Scheduled range of days Formula (7)
Accomplished completion date and hour>Present date and hour−Completion range of days. Formula (8)

7. The work management program of claim 1, wherein the work status includes “Reserved”, “Not started yet”, “Started”, “Interrupted”, “Terminated” and “Settled” statuses,
wherein status of the work that has not yet been started and cannot be started is defined as “Reserved”;
status of the work that has not yet been started and can be started is defined as “Not started yet”;
status of the work being under execution is defined as “Started”;
status of the work being interrupted is defined as “Interrupted”;
status of the work that has been terminated and can be restarted is defined as “Terminated”; and
status of the work that has been terminated and cannot be restarted is defined as “Settled”, wherein the classification function is configured to:
classify the work whose status is “Reserved” as “Scheduled” work status;
classify the work whose status is “Not started yet”, “Started”, “Interrupted” or “Terminated” as “Entry” work status; and
classify the work whose status is “Settled” as “Completed” work status.

8. The work management program of claim 1, further comprising a renewing function to receive an instruction and renew the work information displayed, and when the instruction is received by the renewing function, the work management program being configured to conduct:
the selecting function to select work information;
the acquiring function to acquire the work information selected; and
the display function to display the work information acquired.

9. The work management program of claim 1, wherein the work is set on the job of prepress.

10. A work management system for managing a work set on a job as a work item, comprising:
a work information storing section for storing the work information including a name and status of the work;
a classification section for classifying the work status into any one of the “scheduled”, “entry” and “completed” statuses;
a selecting section for selecting the work information, satisfying a predetermined condition, of the work in either “scheduled” or “completed” status as classified by the classification section, and selecting the work information on the work in the “entry” status as classified by the classification function;
an acquiring section for acquiring the work information selected; and
a display section for displaying the work information acquired.

11. The work management system of claim 10, wherein the work information includes a work name, work status, a scheduled entry date and an accomplished completion date.

12. The work management system of claim 11, further comprising:
a range-of-days storing section for storing a scheduled range of days and a completion range of days; and
a present date storing section for storing the present date;
wherein the predetermined condition is to satisfy the formula (1) for the work information of the work in the “scheduled” work status, and to satisfy the formula (2) for the work information of the work in the “completed” work status,
Scheduled entry date≦Present date+Scheduled range of days Formula (1)
Accomplished completion date≧Present date−Completion range of days. Formula (2)

13. The work management system of claim 11, further comprising:
a range-of-days storing section for storing a scheduled range of days and a completion range of days; and
a present date storing section for storing the present date;
wherein the predetermined condition is to satisfy the formula (3) for the work information of the work in the “scheduled” work status, and to satisfy the formula (4) for the work information of the work in the “completed” work status,
Scheduled entry date<Present date+Scheduled range of days Formula (3)
Accomplished completion date>Present date−Completion range of days. Formula (4)

14. The work management system of claim 11, further comprising:
a range-of-days storing section for storing a scheduled range of days and a completion range of days; and
a present date and hour storing section for storing the present date and hour;
wherein the predetermined condition is to satisfy the formula (5) for the work information of the work in the “scheduled” work status, and to satisfy the formula (6) for the work information of the work in the “completed” work status,
Scheduled entry date and hour≦Present date and hour+Scheduled range of days Formula (5)
Accomplished completion date and hour≧Present date and hour−Completion range of days. Formula (6)

15. The work management system of claim 11, further comprising:
a range-of-days storing section for storing a scheduled range of days and a completion range of days; and
a present date and hour storing section for storing the present date and hour;
wherein the predetermined condition is to satisfy the formula (7) for the work information of the work in the “scheduled” work status, and to satisfy the formula (8) for the work information of the work in the “completed” work status,
Scheduled entry date and hour<Present date and hour+Scheduled range of days Formula (7)
Accomplished completion date and hour>Present date and hour−Completion range of days. Formula (8)

16. The work management system of claim 10, wherein the work status includes “Reserved”, “Not started yet”, “Started”, “Interrupted”, “Terminated” and “Settled” statuses,
wherein status of the work that has not yet been started and cannot be started is defined as “Reserved”;
status of the work that has not yet been started and can be started is defined as “Not started yet”;
status of the work being under execution is defined as “Started”;
state of the work being interrupted is defined as “Interrupted”;
state of the work that has been terminated and can be restarted is defined as “Terminated”; and
state of the work that has been terminated and cannot be restarted is defined as “Settled”,
wherein the classification section classifies the work whose status is “Reserved” as “Scheduled” work status; whose status is “Not started yet”, “Started”, “Interrupted” or “Terminated” as “Entry” work status; and classifies the work whose status is “Settled” as “Completed” work status.

17. The work management system of claim 10, further comprising a renewing section for receiving an instruction to renew the work information displayed by the display section,
wherein when the instruction to renew the work information has been received by the renewing section, the selecting section selects the work information, the acquiring section acquires the work information selected, and the display section displays the work information acquired.

18. The work management system of claim 10, wherein the work is set on the job of prepress.

19. A computer-readable recording medium for recording a work management program to allow a computer to perform the function of managing a work set on the job as a work item, the work management program comprising:
a work information storing function to store work information including a work name and work status;
a classification function to classify the work status into any one of “scheduled” work status, “entry” work status and “completed” work status;
a selecting function to select work information, satisfying a predetermined condition, of the work classified to either the “scheduled” work status or the “completed” work status, and work information of the work classified to the “entry” work status;
an acquiring function to acquire the work information selected; and
a display function to display the work information acquired.

20. The computer-readable recording medium of claim 19, wherein the work information includes the work name, the work status, a scheduled entry date and an accomplished completion date.

21. The computer-readable recording medium of claim 20, wherein the work management program further comprising:
a range-of-days storing function to store a range of days including a scheduled range of days, and a completion range of days; and
a present date storing function to store a present date,
wherein the predetermined condition is to satisfy a formula (1) for the information of the work in the “scheduled” work status, and to satisfy a formula (2) for the information of the work in the “completed” work status,
Scheduled entry date≦Present date+Scheduled range of days Formula (1)
Accomplished completion date≧Present date−Completion range of days. Formula (2)
